(19) United States
(12) Patent Application Publication
(10) Pub. No.: US 2011/0173457 A1
(43) Pub. Date: Jul. 14, 2011

(54) ENHANCED SECURITY FOR OVER THE AIR (OTA) FIRMWARE CHANGES

(76) Inventor: Jeffrey Reh, Longmont, CO (US)

(21) Appl. No.: 12/856,321

(22) Filed: Aug. 13, 2010

Related U.S. Application Data
(60) Provisional application No. 61/234,141, filed on Aug. 14, 2009.

(51) Int. Cl. G06F 12/14

(52) U.S. Cl. 713/191

(57) ABSTRACT

A system and method for providing enhanced security for Over The Air (OTA) firmware changes defers decryption of a firmware image until it is transferred into a protected internal memory of a wireless device. An updated firmware image is encrypted at a source and transmitted to a wireless device having a processor, internal memory, and external memory. The wireless device stores the encrypted firmware image in its external memory. In response to receiving an instruction to load a new firmware image, the processor retrieves the encrypted firmware image from the external memory. The processor decrypts the encrypted firmware image and programs the internal memory in accordance with the decrypted firmware image.

### CROSS-REFERENCE TO RELATED APPLICATION(S)

This application claims priority to, and incorporates by reference in its entirety, U.S. Provisional Patent Application No. 61/234,141, entitled “Enhanced Security for Over the Air (OTA) Firmware Changes,” filed on Aug. 14, 2009.

### TECHNICAL FIELD

The present technology relates to systems and methods for providing security for firmware. More specifically, the present technology relates to deferring decryption of a firmware image until it is transferred into a protected internal memory of a wireless device.

### BACKGROUND

A wireless device, such as a sensor, typically includes a microprocessor or microcontroller that operates the device in accordance with an application, or firmware, stored in memory. Periodically, the firmware may need to be updated or changed. For example, the firmware may require updates due to bug fixes, feature additions, data changes, or other modifications. Wireless devices typically have a lifetime of many years. After a wireless device has been deployed, rather than requiring the device to be returned to a device manufacturer or other central location to receive firmware updates, an Over The Air (OTA) mechanism can be employed to facilitate remote firmware updates.

An existing method of updating a wireless device application using an OTA mechanism includes downloading an encrypted firmware image to the device, decrypting the firmware image, and storing the decrypted firmware image in an external memory device. Another method includes downloading an unencrypted firmware image and storing this unencrypted firmware image in an external memory device. Both of these methods have the disadvantage that the final firmware image resides on the external methods have the disadvantage that the final firmware image resides on the external memory device “in the clear,” or in a decrypted or unencrypted format. Many firmware images include network, personal, and/or sensitive information that a wireless device user or owner wants to protect. If the firmware image is stored in a plain, unencrypted format, unauthorized users can read the stored information, compromising the wireless device and/or the associated network.

### SUMMARY

A system and method for providing enhanced security for Over The Air (OTA) firmware changes defers decryption of a firmware image until it is transferred into a protected internal memory of a wireless device. An updated firmware image is encrypted at a source and transmitted to the wireless device. The wireless device stores the received firmware image in its encrypted format, delaying decryption of the firmware image until it is transferred into protected internal memory.

### BRIEF DESCRIPTION OF THE DRAWINGS

FIG. 1 is a block diagram of a system for transmitting an updated firmware image to a wireless device.

FIG. 2 is a block diagram of a system for performing an OTA device update.

### DETAILED DESCRIPTION

A system and method for providing enhanced security for Over The Air (OTA) firmware changes defers decryption of a firmware image until it is transferred into a protected internal memory of a wireless device. An updated firmware image is encrypted at a source and transmitted to the wireless device. The wireless device stores the received firmware image in its encrypted format, delaying decryption of the firmware image until it is transferred into protected internal memory.

Among other benefits, the technology described herein protects the information contained in a firmware image from being read by unauthorized users. According to the described technology, a firmware image is never exposed in its decrypted format, protecting the wireless device and its associated network.

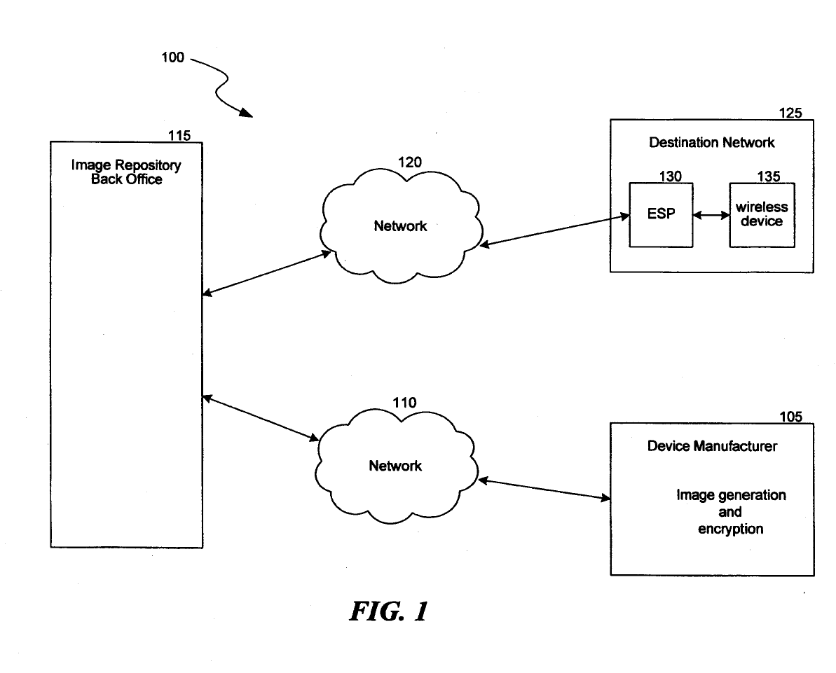

FIG. 1 is a block diagram of a system 100 for transmitting an updated firmware image to a wireless device. A device manufacturer 105 generates an updated firmware image that includes a firmware update, bug fix, feature addition, data change, and/or other modification. The updated firmware image may include any suitable update or modification, including any prior versions of the firmware, features, and/or data. The device manufacturer 105 encrypts the updated firmware image according to one or more encryption methods. Once the updated firmware image has been encrypted, the device manufacturer 105 transmits the encrypted firmware image to an image repository back office, or database, 115, via a network 110. The image repository back office 115 provides a staging area for the encrypted firmware image. In some embodiments, the encrypted firmware image can reside at the staging area for an unlimited amount of time, while in other embodiments, the encrypted firmware image resides at the staging area for a limited amount of time.

When a wireless device 135 is to be updated in accordance with the updated firmware image, the encrypted firmware image is transmitted from the image repository back office 115 to a destination network 125 on which the wireless device resides 135. The image repository back office 115 transmits the encrypted firmware image to the destination network 125 via a network 120. The destination network 125 may comprise a local home area network (HAN) or other network. Although FIG. 1 depicts networks 110 and 120 as separate networks, one skilled in the art will appreciate that the networks 110 and 120 may be the same network.

In some embodiments, prior to transmitting the encrypted firmware image to the destination network 125, the image repository back office 115 further encrypts the image. That is, the image repository back office 115 adds its own, additional encryption on top of the encryption applied by the device manufacturer 105.

The destination network 125 includes an Energy Service Portal (ESP) device 130 and one or more wireless devices, including the wireless device 135 for which the updated firmware image is intended. In some embodiments, the destination network 125, the ESP device 130, and one or more of the network wireless devices operate in accordance with the ZigBee Smart Energy (SE) protocol. In some embodiments, the ESP device functions may physically reside within wireless device 135 or one of the other wireless devices in the destination network 125.

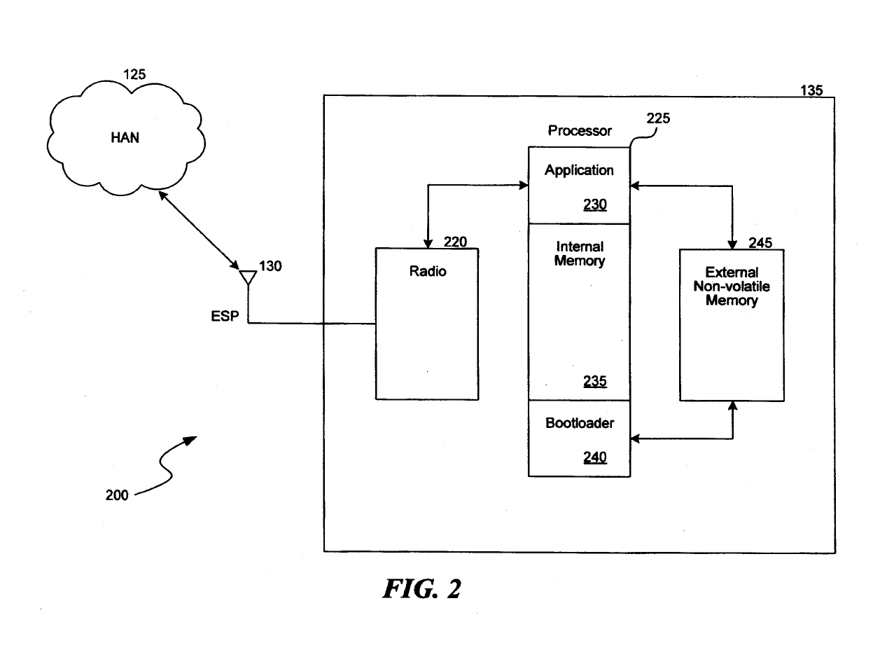

The ESP device 130 receives the encrypted firmware image from the image repository back office 115. The ESP device 130 forwards the encrypted firmware image to the wireless device 135 for which it is intended. The wireless device 135 receives the encrypted firmware image and initiates an OTA device update, described in reference to FIG. 2. In some embodiments, the ESP device 130 updates one network wireless device 135 at a time, while in other embodiments, the ESP device 130 initiates updates on multiple network wireless devices 135 at the same time.

Although FIG. 1 depicts communications made directly between the ESP device 130 and the wireless device 135, one skilled in the art will appreciate that these communications may be routed through one or more intermediate wireless network devices in the destination network 125.

FIG. 2 is a block diagram of a system 200 for performing an OTA device update. A wireless device 135 receives an encrypted firmware image from an ESP device 130 on a destination network, such as a local HAN, 125, as described in reference to FIG. 1. The wireless device 135 includes a radio 220, a processor 225, and external nonvolatile memory 245. The processor includes an application, or firmware, 230, an internal memory 235, and a bootloader 240. In some embodiments, the internal memory 235 comprises flash memory.

The device radio 220 receives the encrypted firmware image from the local HAN 125. The device radio 220 transfers the encrypted firmware image in segments to the application 230 of the device processor 225. The application 230 executes in the internal memory 235 of the processor 225. Once the application 230 has received the encrypted firmware image segment from the device radio 220, the application 230 stores the received image segment in the external nonvolatile memory 245 of the device. This process repeats until the entire firmware image update is loaded into the external nonvolatile memory 245. In some embodiments, the encrypted firmware image may securely reside in the external nonvolatile memory 245 for an indefinite period of time, while in other embodiments, the firmware image may securely reside in the external nonvolatile memory 245 for a definite period of time.

After the encrypted firmware image has successfully been stored in the external nonvolatile memory 245 by the application 225, the wireless device 135 awaits a command from the HAN 125 to perform the load of the new firmware image into the internal memory 235. Once instructed to load the new firmware image into the internal memory 235, the bootloader 240 of the processor 225 reads the encrypted image from the external nonvolatile memory 245. In general, an OTA application relies on a bootloader to reprogram the processor with a new firmware image. Under existing methods for updating a wireless device application, which provide a firmware image to the bootloader in a final, decrypted format, the bootloader is designed in a relatively simple manner. Under the technology described herein, the bootloader 240 includes additional functionality that allows the bootloader 240 to decrypt an encrypted firmware image. Once the bootloader reads the encrypted image from the external nonvolatile memory 245, the bootloader 240 decrypts the encrypted firmware image and programs the internal memory 235 of the processor 225 in accordance with the updated firmware image.

Although not required, aspects of the technology described herein may be implemented as computer-executable instructions, such as routines executed by a general or special purpose data processing device (e.g., a server or client computer). Aspects of the technology described herein may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the technology may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

From the foregoing, it will be appreciated that specific embodiments of the technology have been described herein for purposes of illustration, but that various modifications may be made without deviating from the spirit and scope of the described technology. For example, the described technology is applicable to any wireless device that implements an OTA mechanism, including cellular phones, PDAs, and other wireless devices. Accordingly, the technology is not limited except as by the appended claims.

I/We claim:

1. A method in a wireless device of providing security for firmware, the wireless device having a processor, internal memory, and external memory, the method comprising:
receiving by the processor an encrypted firmware image;
storing the encrypted firmware image in the external memory;
receiving by the processor an instruction to load a new firmware image in the internal memory;
in response to receiving the instruction, retrieving by the processor the encrypted firmware image from the external memory;
decrypting by the processor the encrypted firmware image; and
programming the internal memory in accordance with the decrypted firmware image.

2. The method of claim 1, wherein the receiving by the processor the encrypted firmware image comprises:
receiving by the processor the encrypted firmware image from an energy service portal device.

3. The method of claim 2, wherein the receiving by the processor the encrypted firmware image from the energy service portal device comprises:
receiving by the processor the encrypted firmware image from the energy service portal device via a home area network.

4. The method of claim 1, wherein the receiving by the processor the encrypted firmware image comprises:
receiving by the processor a portion of the encrypted firmware image.

5. The method of claim 1, wherein the storing the encrypted firmware image in the external memory comprises:
storing a portion of the encrypted firmware image in the external memory.

6. The method of claim 1, wherein the storing the encrypted firmware image in the external memory comprises:
storing the encrypted firmware image in the external memory for a certain time period.

7. The method of claim 1, wherein the storing the encrypted firmware image in the external memory comprises:
storing the encrypted firmware image in the external memory for an unspecified time period.

8. A system for providing security for firmware, the system comprising:
external memory configured to store an encrypted firmware image; and
a processor coupled to the external memory, the processor comprising:
internal memory; and
a bootloader configured to:
retrieve the encrypted firmware image from the external memory;
decrypt the encrypted firmware image; and
program the internal memory based on the decrypted firmware image.

9. The system of claim 8, wherein system further comprises:
a radio configured to:
receive the encrypted firmware image from an energy service portal device; and
transfer the encrypted firmware image to an application, and
wherein the processor further comprises:
the application configured to:
receive the encrypted firmware image from the radio; and
store the encrypted firmware image in the external memory.

10. The system of claim 8, wherein the radio is configured to transfer the encrypted firmware image to the application a segment at a time, and wherein the application is configured to store the encrypted firmware image in the external memory a segment at a time.

11. The system of claim 8, wherein the external memory is configured to store the encrypted firmware image for a definite period of time.

12. The system of claim 8, wherein the external memory comprises nonvolatile memory.

13. The system of claim 8, wherein the internal memory comprises flash memory.

14. The system of claim 8, wherein the system operates in accordance with the ZigBee Smart Energy protocol.

15. The system of claim 8, wherein the bootloader is configured to retrieve the encrypted firmware image from the external memory in response to receiving a command from a home area network to load a new firmware image into the internal memory.

16. A tangible computer-readable medium having stored thereon instructions for providing security for firmware, the instructions comprising:
Instructions for receiving an encrypted firmware image;
Instructions for storing the encrypted firmware image in an external memory;
instructions for retrieving the encrypted firmware image from the external memory;
instructions for decrypting the encrypted firmware image; and
instructions for programming an internal memory in accordance with the decrypted firmware image.

17. The computer-readable medium of claim 16, wherein the instructions for retrieving the encrypted firmware image from the external memory comprise:
Instructions for receiving a command to load a new firmware image into the internal memory; and
In response to receiving the command, Instructions for retrieving the encrypted firmware image from the external memory.

18. The computer-readable medium of claim 16, wherein the instructions for receiving the encrypted firmware image comprise:
Instructions for receiving the encrypted firmware image from an energy service portal device.

19. The computer-readable medium of claim 18, wherein the instructions for receiving the encrypted firmware image from the energy service portal device comprise:
Instructions for receiving the encrypted firmware image from the energy service portal device via a home area network.

20. The computer-readable medium of claim 16, wherein the encrypted firmware image includes at least one of a firmware update, a bug fix, a feature addition, or a data change.
